(19) United States
(12) Patent Application Publication
(10) Pub. No.: US 2004/0248014 A1
(43) Pub. Date: Dec. 9, 2004

(54) Electrolyte including polysiloxane with cyclic carbonate groups

(76) Inventors: Robert C. West, Madison, WI (US); Zhengcheng Zhang, Madison, WI (US); Khalil Amine, Downers Grove, IL (US)

Correspondence Address: Quallion LLC, P.O. Box 923127, Sylmar, CA, 91392-3127, US

(21) Appl. No.: 10/810,081

(22) Filed: Mar. 25, 2004

Related U.S. Application Data
(63) Continuation-in-part of application No. PCT/US03/08783, filed on Mar. 20, 2003.
(60) Provisional application No. 60/502,017, filed on Sep. 10, 2003.
(60) Provisional application No. 60/451,065, filed on Feb. 26, 2003.
(60) Provisional application No. 60/443,892, filed on Jan. 30, 2003.
(60) Provisional application No. 60/446,848, filed on Feb. 11, 2003.

(51) Int. Cl. H01M 10/40

(52) U.S. Cl. 429/313; 429/317; 429/189

(57) ABSTRACT

The electrolyte includes a polysiloxane having one or more backbone silicons linked to a first side chain and one or more backbone silicons linked to a second side chain. The first side chains include a poly(alkylene oxide) moiety and the second side chains include a cyclic carbonate moiety. The electrolyte can be a liquid.

### REFERENCE TO RELATED APPLICATIONS

This application claims priority to Provisional U.S. Patent Application Ser. No. 60/502,017, filed on Sep. 10, 2003, entitled “Electrolyte Including Polysiloxane with Cyclic Carbonate Groups” and incorporated herein in its entirety.

This Application is a Continuation-in-Part of International Application PCT/US03/08783; filed on Mar. 20, 2003; and entitled “Method for Fabricating Composite Electrodes” which claims priority to provisional application Ser. No. 60/451,065; filed Feb. 26, 2003; and entitled “Method for Fabricating Composite Electrodes”; and which also claims priority to provisional application Ser. No. 60/443,892; filed Jan. 30, 2003; and entitled “Nonaqueous Liquid Electrolyte”; and which also claims priority to provisional application Ser. No. 60/446,848; filed Feb. 11, 2002; entitled “Polymer Electrolyte for Electrochemical Cell” and which also claims priority to PCT Application number PCT/US03/02127; filed Jan. 22, 2003; and entitled “Nonaqueous Liquid Electrolyte” and which also claims priority to PCT/US03/02128; filed Jan. 22, 2003; and entitled “Solid Polymer Electrolyte and Method of Preparation” and which also claims priority to U.S. patent application Ser. No. 10/167,940; filed Jun. 12, 2002; and entitled “Nonaqueous Liquid Electrolyte” which is a Continuation-in-Part of co-pending application Ser. No. 10/104,352, filed Mar. 22, 2002. Each of the above applications is incorporated herein in its entirety, including all disclosures submitted therewith.

This application is also related to U.S. patent application Ser. No. XXX, filed on XXX, entitled “Polysiloxane for Use in Electrochemical Cells” and incorporated herein by reference in its entirety.

### STATEMENT REGARDING FEDERALLY SPONSORED RESEARCH OR DEVELOPMENT

This invention was made with United States Government support under NIST ATP Award No. 70NANB043022 awarded by the National Institute of Standards and Technology (NIST). The United States Government has certain rights in this invention pursuant to NIST ATP Award No. 70NANB043022 and pursuant to Contract No. W-31-109-ENG-38 between the United States Government and the University of Chicago representing Argonne National Laboratory, and NIST 144 LM01, Subcontract No. AGT DTD Sep. 9, 2002.

### FIELD

The present invention relates to electrolytes for electrochemical devices, and more particularly to electrolytes that include polysiloxanes.

### BACKGROUND

The increased demand for lithium secondary batteries has resulted in research and development to improve the safety and performance of these batteries. Many batteries employ liquid electrolytes associated with high degrees of volatility, flammability, and chemical reactivity. A variety of polysiloxane based electrolytes have been developed to address these issues. However, these polysiloxane based electrolytes typically have a low ionic conductivity that limits their use to applications that do not require high rate performance. As a result, there is a need for electrolytes that include polysiloxane-based electrolytes with an increased ionic conductivity.

### SUMMARY

A electrolyte for use in an electrochemical device is disclosed. The electrolyte includes a salt and a polysiloxane having one or more backbone silicons linked to a first side chain and one or more backbone silicons linked to a second side chain. The first side chains include a poly(alkylene oxide) moiety and the second side chains include a cyclic carbonate moiety.

The electrolyte can be a liquid. In some instances, the electrolyte includes a network polymer that interacts with the polysiloxane so as to form an interpenetrating network. The network polymer can serve as a mechanism for providing a solid electrolyte or gel electrolyte. Alternately, the electrolyte can include one or more solid polymers that are each a solid at room temperature when standing alone. The solid polymer can be employed to generate a solid electrolyte such as a plasticized electrolyte.

The invention also relates to a method of forming an electrochemical device. The method includes generating an electrolyte that includes a polysiloxane having one or more backbone silicons linked to a first side chain and one or more backbone silicons linked to a second side chain. The first side chains include a poly(alkylene oxide) moiety and the second side chains include a cyclic carbonate moiety. The electrolyte can also include a cross-linked network polymer or a solid polymer. The network polymer can include interstices in which the polysiloxane is positioned and the solid polymer can be a solid when standing alone at room temperature. The method also includes activating one or more electrodes and one or more anodes with the electrolyte.

The polysiloxane can have a structure according to General Formula I:

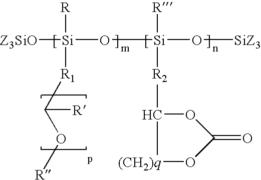

where R is an alkyl group; R′ is hydrogen or an alkyl group; R″ is an alkyl group; R′″ is alkyl; R₁ is an alkylene, alkylene oxide or bivalent ether moiety; R₂ is an alkylene, alkylene oxide or bivalent ether moiety; m is greater than or equal to 1; n is greater than or equal to 1; p is 3 to 20; q is 1 to 2; and Z is a terminal group such as an alkyl or aryl group.

A precursor solution for use in generating a polysiloxane is also disclosed. The solution includes a polysiloxane precursor where each of the non-terminal backbone silicons is bonded to a hydrogen atom; a first side-chain precursor including a poly(alkylene oxide) moiety and being allyl terminated; and a second side-chain precursor including a cyclic carbonate moiety and being allyl terminated. In some instances, the polysiloxane precursor, the first side-chain precursor and the second side-chain precursor are present in the solution so as to provide the solution with a [SC]/[Si—H] ratio greater than 1:1. The [SC]/[Si—H] ratio is the ratio of (the molar concentration of the first side-chain precursor in the solution+the molar concentration of the second side-chain precursor in the solution): (the molar concentration of the Si—H groups on backbone of the polysiloxane precursor in the solution). In some instances, the components are present in the precursor solution such that [SC]/[Si—H] is greater than 1:1 and/or less than 3:1. Additionally, the components can be present in the precursor solution such that a side-chain precursor ratio is greater than 1:1. The side-chain precursor ratio is the ratio of the molar concentration of the second side-chain precursor to the molar concentration of the first side-chain precursor.

A method of forming the electrolyte is also disclosed. The method includes generating a precursor solution that includes a polysiloxane precursor having non-terminal backbone silicons that are a member of at least one Si—H group; a first side-chain precursor including a poly(alkylene oxide) moiety and being allyl terminated; and a second side-chain precursor including a cyclic carbonate moiety and being allyl terminated. The components are mixed so as to provide a [SC]/[Si—H] ratio greater than 1:1. The method can also include reacting the components of the precursor solution so as to form a product solution that includes a polysiloxane having one or more backbone silicons linked to a first side-chain and one or more backbone silicons linked to a second side-chain. The first side-chains include a poly(alkylene oxide) moiety and the second side-chains include a cyclic carbonate moiety.

### BRIEF DESCRIPTION OF THE FIGURES

FIG. 1 illustrates an example of a method for employing a hydrosilylation reaction to generate a polysiloxane having side chains that include a poly(alkylene oxide) moiety and side chains that include a cyclic carbonate moiety.

FIG. 2 illustrates a generalized reaction for generating a first side-chain precursor that includes a poly(alkylene oxide) moiety.

FIG. 3 illustrates a generalized reaction for generating a second side-chain precursor that includes a cyclic carbonate moiety.

### DETAILED DESCRIPTION

An electrolyte suitable for use in electrochemical devices such as batteries, electrochemical cells, and capacitors is disclosed. The electrolyte includes a salt and a polysiloxane. The polysiloxane has side chains that include a poly(alkylene oxide) moiety and side chains that include a carbonate moiety. The carbonate moiety can have a high ability to dissolve the salts that are employed in electrolytes. As a result, the carbonates can provide high concentrations of free ions in the electrolyte and can accordingly increase the ionic conductivity of the electrolyte. The poly(alkylene oxide) moieties can act as substrates for ion coordination and transportation. As a result, the poly(alkylene oxide) moiety and the carbonate moiety can act together to provide an electrolyte with an enhanced ionic conductivity.

A suitable poly(alkylene oxide) moiety for the side chains includes, but is not limited to, a poly(ethylene oxide) moiety. In some instances, the poly(ethylene oxide) moiety includes 3 to 20 repeating units. Suitable carbonate moieties for use in the side chains include cyclic carbonate moieties. The cyclic carbonate moieties can be substituted or unsubstituted. In some instances, the cyclic carbonate moieties include a ring having 5 to 6 members.

A first spacer can link the backbone silicons to the cyclic carbonate moiety. Additionally or alternatively, a second spacer can link the backbone silicons to the cyclic carbonate moiety. The first spacer and/or the second spacer can include one or more carbons. For instance, the first spacer and/or the second spacer can include one or more CH₂ groups.

In some instances, the polysiloxane are generated such that each of the non-terminal backbone silicons is linked to a first side chain that includes a poly(alkylene oxide) moiety or to a second side chain that includes a cyclic carbonate moiety. The polysiloxane can be generated such that one or more of the non-terminal backbone silicons is linked to two side chains. The side chains linked to a single silicon can be the same or different.

The electrolyte can be a liquid, a solid or a gel. The polysiloxanes are generally liquids at room temperature. As a result, the electrolyte can be a liquid. Further, the electrolyte can include a network polymer that forms an interpenetrating network with the polysiloxane. An electrolyte that includes an interpenetrating network can be a solid or a gel. Accordingly, the network polymer can serve as a mechanism for providing a solid electrolyte or a gel electrolyte. Alternately, the electrolyte can include one or more solid polymers in addition to the polysiloxane. The one or more solid polymers are a solid when standing alone at room temperature. The solid polymer can be employed to generate a gel electrolyte or a solid electrolyte such as a plasticized electrolyte.

Examples of polysiloxanes that are suitable for use in the electrolyte are represented by General Formula I:

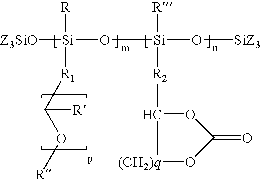

where R is an alkyl group; R′ is hydrogen or an alkyl group; R″ is an alkyl group; R′″ is alkyl; R₁ is a spacer that can be an alkylene, alkylene oxide or bivalent ether moiety; R₂ is a spacer that can be an alkylene, alkylene oxide or bivalent ether moiety; m is greater than or equal to 1, n is greater than or equal to 1; m +n can be 4 to 40; a ratio of n:m can be 1:1 tol:100 and is preferably 1:5 to 1:20 and is more preferably 1:5 to 1:15; p is 3 to 20; q is 1 to 2; and Z is a terminal group such as an alkyl or aryl group. The terminal groups, Z, bonded to a single Si can be the same or different. The m silicons need not be positioned adjacent to one another along the backbone and can be positioned among the n silicons.

When a polysiloxane according to General Formula I is to be employed in an electrolyte, a suitable average molecular weight for the polysiloxane includes, but is not limited to, an average molecular weight less than or equal to 4000 g/mole.

The above polysiloxanes are liquids at room temperature. A liquid electrolyte for use in an electrochemical device can be generated by dissolving a salt in the one or more polysiloxanes. Where the electrolyte is to be solidified or gelled, the salt is preferably dissolved in the electrolyte before solidification or gelling of the electrolyte. In some instances, the electrolyte is prepared such that the concentration of the salt in the electrolytes is about 0.3 to 2.0 M, about 0.5 to 1.5 M, or about 0.7 to 1.2 M. Other concentrations are possible. Suitable salts for use with the electrolyte include, salts that include lithium and salts that exclude lithium. As a result, the polysiloxane is suitable for use in the electrolytes of electrochemical devices such as batteries and capacitors. Suitable lithium salts for use in the electrolyte include, but are not limited to, LiClO₄, LiBF₄, LiAsF₆, LiPF₆, LiCF₃SO₃, Li(CF₃SO₂)₂N, Li(CF₃SO₂)₃C, LiN(SO₂C₂F₅)₂, lithium alkyl fluorophosphates, lithium bis(oxalato)borate (LiB(C₂O₄)₂), as well as other lithium bis(chelato)borates having five to seven membered rings, LiPF₃(C₂F₅)₃, LiPF₃(CF₃)₃, and mixtures thereof.

When a lithium salt is used with the electrolyte, an [EO]/[Li] ratio can be used to characterize the salt in the electrolyte. [EO] is the molar concentration in the electrolyte of the ethylene oxides in the one or more polysiloxanes. Because [EO] is directed to ethylene oxides, there are at least p ethylene oxides in a polysiloxane according to Formulas I. In some instances, the spacers will also include ethylene oxides. For instance, a side chain according to Formula I has p+1 ethylene oxides when R₁ is —(CH₂)₃—O— and the oxygen is bonded to the poly(ethylene) oxide moiety. The electrolyte is preferably prepared so as to have a [EO]/[Li] ratio of 5 to 50. When the [EO]/[Li] ratio is larger than 50, the ionic conductivity of the resulting electrolyte can become undesirably low because few carrier ions are in the electrolyte. When the [EO]/[Li] ratio is smaller than 5, the lithium salt may not sufficiently dissociate in the resulting electrolyte and the aggregation of lithium ions can confine the ionic conductivity.

In some instances, the electrolyte is generated so as to include one or more additives. Additives can serve a variety of different functions. For instance, additives can enhance the ionic conductivity and/or enhance the voltage stability of the electrolyte. A preferred additive forms a passivation layer on one or more electrodes in an electrochemical device such as a battery or a capacitor. The passivation layer can enhance the cycling capabilities of the electrochemical device. In one example, the passivation layer is formed by reduction of the additive at the surface of an electrode that includes carbon. In another example, the additive forms a polymer on the surface of an electrode that includes carbon. The polymer layer can serve as the passivation layer.

Suitable additives include, but are not limited to, carbonates, sulfur compounds, unsaturated hydrocarbons and nitrogen compounds. In some instances, the electrolyte includes at least one additive selected from the group consisting of: vinyl carbonate (VC), vinyl ethylene carbonate (VEC), ethylene sulfite, 1,3 dimethyl butadiene, styrene carbonate, aromatic carbonates, vinyl pyrrole, vinyl piperazine, vinyl piperidine, vinyl pyridine, and mixtures thereof. In one example, the electrolyte includes vinyl ethylene carbonate as an additive. VC is an example of an additive that can be reduced to form a passivation layer that includes a carbonate at the surface of an electrode that includes carbon. Pyridine is an example of an additive that can form a polymeric passivation layer at the surface of an electrode that includes carbon. VEC is an example of an additive that can form a passivation layer by both being reduced and forming a polymer at the surface of an electrode that includes carbon. A suitable concentration for an additive in the electrolyte includes, but is not limited to, concentrations greater than 0.1 wt %, greater than 0.5 wt % and/or less than 5 wt % or less than 20 wt %.

The electrolyte can include a network polymer that forms an interpenetrating network with the polysiloxane. An electrolyte having an interpenetrating network can be generated by polymerizing and/or cross-linking one or more network polymers in the presence of the polysiloxane or by polymerizing and/or cross-linking the polysiloxane in the presence of one or more network polymers. Alternately, an electrolyte having an interpenetrating network can be generated by polymerizing and/or cross-linking one or more network polymers and the polysiloxane in the presence of one another.

Suitable network monomers from which the network polymer can be formed include, but are not limited to, acrylates and methacrylates. Acrylates and/or methacrylates having one or more functionalities can form a polyacrylate and/or a polymethacrylate network polymer. Acrylates and/or methacrylates having two or more functionalities can both polymerize and cross-link to form a cross-linked polyacrylate network polymer and/or to form a cross-linked polymethacrylate network polymer. In some instances, acrylates and/or methacrylates having four or more functionalities are a preferred network monomer. Suitable acrylates include, but are not limited to, poly(alkylene glycol) dialkyl acrylate. Suitable methacrylates include, but are not limited to, poly(alkylene glycol) dialkyl methacrylate.

A suitable network monomer is represented by the following Formula II:

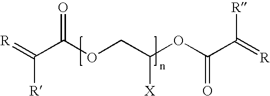

wherein: R is an alkylidene, a carbene, or is represented by CR′″R″″ and each R can be the same or different; R′ represents hydrogen or an alkyl group having 1 to 10 carbon atoms or an alkenyl group having 2 to 12 carbon atoms; R″ represents hydrogen or an alkyl group having 1 to 10 carbon atoms or an alkenyl group having 2 to 12 carbon atoms; R′″ represents hydrogen or an alkyl group having 1 to 10 carbon atoms; R″″ represents hydrogen or an alkyl group having 1 to 10 carbon atoms; X is hydrogen or a methyl group; and n represents a numeral of 1 to 15.

When a monomer that cross-links is employed to form a cross-linked network polymer, a control monomer can be employed to control cross-linking density. A suitable control monomer for use with a network monomer according to Formula II is represented by the following Formula III:

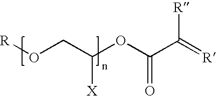

wherein: R is an alkyl group having 1 to 10 carbon atoms; R′ is an alkylidene, a carbene, or is represented by CR′″R″″ is represented by ═CR′″R″″; R″ is hydrogen or an alkyl group having 1 to 10 carbon atoms or an alkenyl group having 2 to 12 carbon atoms; R′″ represents hydrogen or an alkyl group having 1 to 10 carbon atoms; R″″ represents hydrogen or an alkyl group having 1 to 10 carbon atoms; X is hydrogen or a methyl group; and n represents a whole number from 1 to 20. During formation of the network polymer, the illustrated control monomer serves as a co-monomer with the network monomers according to Formula II. Because the control monomer does not cross link, increasing the amount of control monomer present during formation of the network polymer can reduce the density of cross linking.

Diallyl terminated compounds can also be employed as a network monomer. Diallyl terminated compounds having two or more functionalities can polymerize and cross-link to form the network polymer. An example of a diallyl terminated compound having two functionalities that allow the compound to polymerize and cross link is represented by Formula IV.

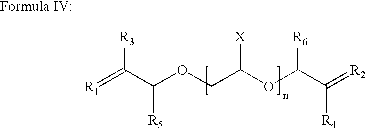

wherein R₁ represents an alkylidene, a carbene, or CR′″R″″, R₂ represents an alkylidene, a carbene, or CR′″R″″; R₃ represents hydrogen or an alkyl group having 1 to 10 carbon atoms or an alkenyl group having 2 to 12 carbon atoms; R4 represents hydrogen or an alkyl group having 1 to 10 carbon atoms or an alkenyl group having 2 to 12 carbon atoms; R₅ represents hydrogen or an alkyl group having 1 to 10 carbon atoms or an alkenyl group having 2 to 12 carbon atoms; R6 represents hydrogen or an alkyl group having 1 to 10 carbon atoms or an alkenyl group having 2 to 12 carbon atoms; R′″represents hydrogen or an alkyl group having 1 to 10 carbon atoms; R″″ represents hydrogen or an alkyl group having 1 to 10 carbon atoms; X is hydrogen or a methyl group; and n represents a numeral of 1 to 15.

Formula V represents an example of a control monomer for controlling the cross linking density of a compound represented by Formula IV.

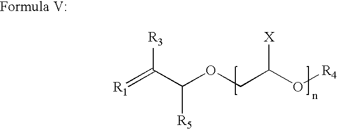

wherein R₁ represents an alkylidene, a carbene, or is represented by CR′″R″″; R₂ represents hydrogen or an alkyl group having 1 to 10 carbon atoms or an alkenyl group having 2 to 12 carbon atoms; R₃ represents hydrogen or an alkyl group having 1 to 10 carbon atoms or an alkenyl group having 2 to 12 carbon atoms; R₄ represents hydrogen or an alkyl group having 1 to 10 carbon atoms or an alkenyl group having 2 to 12 carbon atoms; R′″ represents hydrogen or an alkyl group having 1 to 10 carbon atoms; R″″ represents hydrogen or an alkyl group having 1 to 10 carbon atoms; X is hydrogen or a methyl group; and n represents a numeral of 1 to 15.

A diallyl terminated compound suitable for serving as a network monomer can include more than two functionalities. For instance, the oxygens shown in Formula II can be replaced with CH₂ groups to provide a diallyl terminated compound having four functionalities that allow the compound to polymerize and cross link. Further, the oxygens shown in Formula III can be replaced with CH₂ groups to provide an example of a control monomer for controlling the cross linking density of the diallyl terminated compound. Other suitable diallyl terminated compounds for serving as a network monomer include, but are not limited to, poly(alkylene glycol) diallyl ethers. A specific example includes, but is not limited to, tetra(ethylene glycol) dially ether.

An electrolyte that includes an interpenetrating network can be formed by generating a precursor solution that includes the one or more polysiloxanes, the monomers for forming the cross-linked network polymer and one or more salts. Suitable salts include, but are not limited to, LiClO₄, LiBF₄, LiAsF₆, LiPF₆, LiCF₃SO₃, Li(CF₃SO₂)₂N, Li(CF₃SO₂)₃C, LiN(SO₂C₂F₅)₂), lithium bis(chelato)borate including lithium(oxalato)borate (LiBOB), and lithium alkyl fluorophosphates. The precursor solution can also optionally be generated so as to include one or more radical initiators and/or one or more additives. Suitable radical initiators include, but are not limited to, thermal initiators including azo compounds such as azoisobutyronitrile, peroxide compounds such as benzoylperoxide, and bismaleimide. A control monomer can also optionally be added to the precursor solution to control the cross-linking density of the network monomer. The monomers are cross-linked and/or polymerized to form the electrolyte. In some instance, the temperature of the precursor solution is elevated and/or the precursor solution is exposed to UV to form the electrolyte. The resulting electrolyte can be a liquid, solid or gel. The physical state of the electrolyte can depend on the ratio of the components in the precursor solution.

An electrolyte having an interpenetrating network can also be generated from a polymer and a cross-linking agent for cross linking of the polymer. For instance, a diallyl terminated compound can serve as a cross linking agent for a polysiloxane having a backbone that includes one or more silicons linked to a hydrogen. Examples of suitable diallyl terminated cross-linking agents include, but are not limited to, diallyl-terminated polysiloxanes, diallyl terminated polysiloxanes, diallyl terminated alkylene glycols and diallyl terminated poly(alkylene glycol)s.

The electrolyte can be generated by preparing a precursor solution that includes the polymer, the cross linking agent, the one or more polysiloxanes and one or more salts. The precursor solution can also optionally be generated so as to include one or more catalysts, and/or one or more additives. Suitable catalysts include, but are not limited to, platinum catalysts such as Karstedt's catalyst and H₂PtCl₆. In some instances, an inhibitor is added to the precursor solution to slow the cross-linking reaction enough to permit handling prior to viscosity changing. Suitable inhibitors include, but are not limited to, dibutyl maleate. The polymer is cross-linked to form the electrolyte. In some instances, heat and/or UV energy is also applied to the precursor solution during the reaction of the cross linking precursor and the cross-linking agent.

A network polymer suitable for the interpenetrating network can be formed using other precursors. For instance, the network polymer can be generated from a mixture of monomers and cross-linking agents that are different from one another. The monomers can polymerize and the cross-linking agents can provide cross linking of the resulting polymer. Other examples of methods for generating electrolytes and electrochemical devices that include network polymers are described in U.S. patent application Ser. No. 10/104,352, filed on Mar. 22, 2002, entitled “Solid Polymer Electrolyte and Method of Preparation” and incorporated herein by reference in its entirety.

As noted above, the electrolyte can include one or more solid polymers in addition to one or more polysiloxanes. The solid polymers are each a solid when standing alone at room temperature. As a result, the ratio of solid polymer to the other electrolyte components can be selected so as to provide an electrolyte that is a solid at room temperature. A suitable solid polymer is an aprotic polar polymer or aprotic rubbery polymer. Examples of suitable solid polymers include, but are not limited to, polyacrylonitrile (PAN), poly(methyl methacrylate) (PMMA), poly(vinylidene fluoride) (PVDF), poly(vinylidene fluoride-co-hexafluoropropylene), polystyrene, polyvinyl chloride, poly(alkyl methacrylate), poly(alkyl acrylate), styrene butadiene rubber (SBR), poly(vinyl acetate), poly(ethylene oxide) (PEO) and mixtures thereof.

The electrolyte can be generated by preparing a precursor solution that includes one or more of the polysiloxanes and a solution that includes a solid polymer. The solution can be generated by dissolving the solid polymer in a solvent such as N-methylpyrrolidone (NMP), dimethyl formamide, dimethyl acetamide, tetrahydrofuran, acetonitrile, and/or water. One or more additives can be optionally added to the precursor solution. One or more salts can be added to the precursor solution or the salt can be dissolved in a component of the precursor solution before adding the component to the precursor solution. A solid electrolyte can be formed by evaporating the solvent from the precursor solution.

An electrolyte that includes one or more solid polymers can also be generated by polymerizing a solid polymer in the presence of the polysiloxane. For instance, a precursor solution can be generated so as to include one or more polysiloxanes, monomers for the solid polymer and a radical initiator. Suitable radical initiators include, but are not limited to, thermal initiators including azo compounds such as azoisobutyronitrile, peroxide compounds such as benzoylperoxide, and bismaleimide. The precursor solution can optionally be prepared so as to inlucde one or more additives. One or more salts can be added to the precursor solution or the salt can be dissolved in a component of the precursor solution before adding the component to the precursor solution. The electrolyte can be formed by polymerizing the monomers. As an example, an acrylonitrile monomers can be mixed with the polysiloxane. The acrylonitrile monomers can be polymerized by the application of heat and/or UV to form an electrolyte having a polyacrylonitrile solid polymer.

As is evident from the above discussion, the electrolyte can include components in addition to the one or more polysiloxanes. For instance, the electrolyte can include salts, additives, network polymers and/or solids polymers. In some instances, the electrolyte is generated such that the one or more polysiloxanes are more than 20 wt % of the electrolyte, more than 50 wt % of the electrolyte, more than 80 wt % of the electrolyte or more than 95 wt % of the electrolyte.

The polysiloxanes described above can be generated using a hydrosilylation reaction between a polysiloxane precursor and side-chain precursors. A suitable polysiloxane precursor includes non-terminal silicons that are each a member of a Si—H group. A portion of the side-chain precursors include a cyclic carbonate substituted with an allyl terminated spacer precursor. Another portion of the side-chain precursors include a poly(alkylene oxide) moiety linked to an allyl terminated spacer precursor.

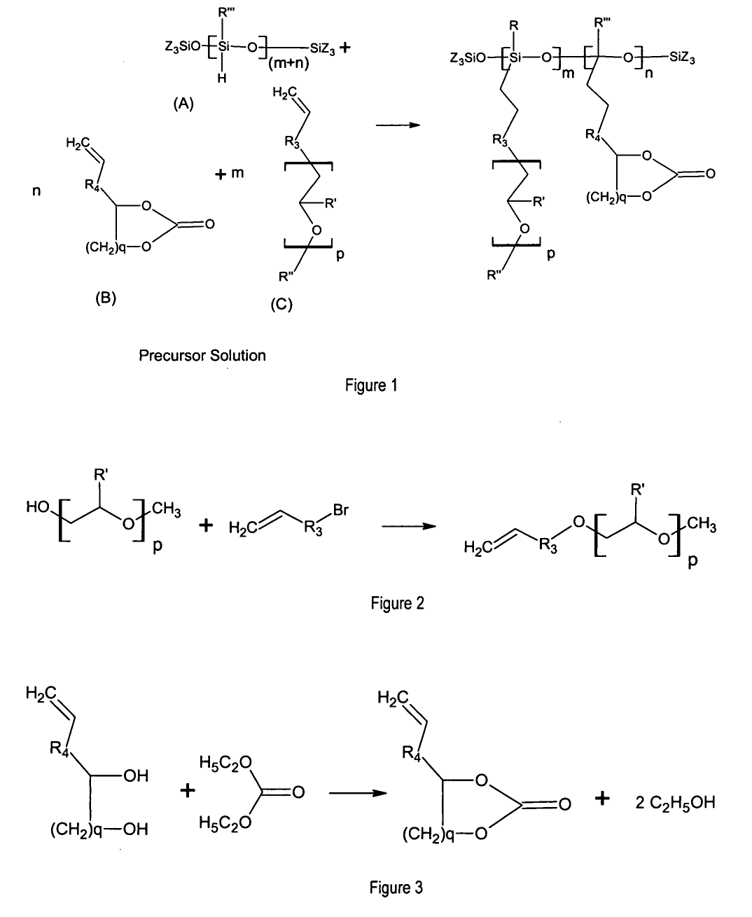

FIG. 1 illustrates an example of a method for employing hydrosilylation to generate the above polysiloxanes. The method includes forming a precursor solution by mixing a precursor polysiloxane labeled component (A), a second side-chain precursor labeled component (B) and a first side-chain precursor labeled component (C). The precursor polysiloxane includes m+n non-terminal backbone silicons that are each bonded to a hydrogen. The second side-chain precursor includes a cyclic carbonate substituted with an allyl-terminated spacer precursor. The allyl-terminated spacer precursor is represented by R₄—CH═CH₂ where R₄ can be nil or can include one or more carbons. For instance, R₄ can include one or more CH₂ groups. Further, R₄ can be an alkylene, alkylene oxide or bivalent ether moiety. In one example, R₄ represents —CH₂—O—CH₂—. The first side-chain precursor includes a poly(alkylene oxide) moiety linked to an allyl-terminated spacer precursor. The allyl-terminated spacer precursor is represented by —R₃—CH═CH₂ where R₃ can be nil or can include one or more carbons. For instance, R₃ can include one or more CH₂ groups. Further, R₃ can be an alkylene, alkylene oxide or bivalent ether moiety. In one example, R₃ represents —O—CH₂— with the oxygen bonded to the poly(ethylene oxide) moiety. The remaining variables shown in FIG. 1 are defined above.

A ratio [SC]/[Si—H] can be employed to characterize the component concentrations in the precursor solution. [SC]/[Si—H] is the ratio of (the molar concentration of the first side-chain precursor plus the molar concentration of the second side-chain precursor) to (the molar concentration of the Si—H groups on backbone of the polysiloxane precursor). When the [SC]/[Si—H] ratio is greater than 1, the hydrogens in each Si—H group can be replaced with a side chain. As a result, the Si—H groups on backbone of the polysiloxane precursor can be depleted during the reaction of the precursor solution. [SC]/[Si—H] can be greater than 1 to ensure that each of the Si—H groups is replaced by a silicon to side-chain bond. SiH groups in the electrolyte can oxidize and lead to later reactivity. Suitable [SC]/[Si—H] ratios include, but are not limited to, [SC]/[Si—H] ratios greater than 1.1 and/or less than 3:1.

A side-chain precursor ratio can also be employed to characterize the ratio of the components in the precursor solution. The side-chain precursor ratio is the ratio of the molar concentration of the second side-chain precursor to the molar concentration of the first side-chain precursor. The side-chain precursor ratio affects the ratio of n:m in the product polysiloxane. For instance, increasing the side-chain precursor ratio increases the ratio of n:m. Suitable side-chain precursor ratios include, but are not limited to, ratios greater than 1:1 and/or less than 1:20.

In some instances, a catalyst is added to the precursor solution to react the components of the precursor solution. Suitable catalysts for use in the precursor solution include, but are not limited to, platinum catalysts such as Karstedt's catalyst, dicyclopentadiene platinum(II) dichloride, H₂PtCl₆. In some instances, a reaction solvent is added to the precursor solution. A suitable solvent includes, but is not limited to, CH₃CN. In some instances, heat is applied to the precursor solution to react the components of the precursor solution. The reaction is continued until the Si—H groups are no longer evident on an NMR spectrum. The product solution can be distilled to remove any unreacted side-chain precursors and/or reaction solvent. In some instances, the product is purified by distillation. The product can be purified by distillation using a long vacuum-jacketed Vigreux column and/or by sequentially performing two or more regular distillations. The regular distillations can be vacuum distillations. When a sequence of two or more regular distillations is performed, a central fraction of the distillate can be used as the product for each distillation step.

Although FIG. 1 illustrates formation of a polysiloxane with each of the non-terminal backbone silicons bonded to a single side-chain, the reaction of FIG. 1 can be adapted so as to provide a polysiloxane with one or more of the non-terminal backbone silicons bonded to a plurality of side-chains. For instance, all or a portion of the R and the R′″ substituents shown in the polysiloxane precursor labeled (A) can be hydrogens. During the reaction, the side chains can replace each of the silicon-bonded hydrogens to provide a product polysiloxane where all or a portion of the non-terminal backbone silicons are bonded to a plurality of side chains.

FIG. 2 illustrates a generalized reaction for generating a first side-chain precursor. The variables shown in FIG. 2 are defined above. The reaction can occur in the presence of heat, a reaction solvent and/or a catalyst. Suitable catalysts include, but are not limited to, NaH, t-BuOK and/or N-BuLi. Suitable reaction solvents include, but are not limited to, tetrahydrofuran (THF). FIG. 3 illustrates a generalized reaction for generating a second side-chain precursor. The variables shown in FIG. 3 are defined above. The reaction can occur in the presence of heat and/or a catalyst. Suitable catalysts include, but are not limited to, K₂CO₃ and/or carbonate salts of the group IA metals such as Na₂CO₃.

### EXAMPLE 1

The generalized reaction illustrated in FIG. 2 was employed with: R′ as a hydrogen; R₄ as CH₂; and p as 3 to generate tri(ethylene glycol) methyl allyl ether (AMPEO₃) as a first-side-chain precursor. A solution of tri(ethylene glycol) methyl ether (98.4 g, 0.6 mol, Aldrich) was added dropwise to a suspension of NaH (60% dispersion in mineral oil, Acros Organics)(28.8 g, 0.72 mol) in THF (250 ml) chilled to 0 ° C. This solution was stirred for an additional two hours followed by dropwise addition of allyl bromide (87.1 g, 0.72 mol, Aldrich). The resulting mixture was stirred overnight and then filtered so as to remove the NaBr product and excess NaH. Volatile materials were removed by rotary evaporation to yield an orange oil. Kugelrohr distillation (80° C./0.5 torr) was employed to collect 110 g of product.

### EXAMPLE 2

The generalized reaction illustrated in FIG. 3 was employed with: R₃ as CH₂—O—CH₂; and q as 1 to generate 4-allyloxymethyl-[1,3]dioxolan-2-one as a second-side-chain precursor. Into a 250 ml one-necked reaction flask equipped with a condenser, 66.1 g (0.5 mol) of 3-(allyloxy)-propane-1,2-diol, 177.2 g (1.5 mol, Aldrich) of diethyl carbonate, and 6.6 g (2.5 wt %) of potassium carbonate were added under N₂. The precursor solution was heated to 120° C. and stirred for 24 h while ethanol was distilled out. The mixture was cooled down and filtered. After vacuum removal of the excess diethyl carbonate, the product distillate was collected at 108° C. at 2 torr.

### EXAMPLE 3

The generalized reaction illustrated in FIG. 1 was employed to generate a polysiloxane with: R as CH₃; R′ as hydrogen; R″ as CH₃; R′″ as CH₃; R₃ as CH₂O; R₄ as CH₂OCH₂; Z as methyl; n:m=1: 9; n+m˜33; p=3; and q=1. To a 3-necked, 250 mL, flame dried flask equipped with a condenser was added 15.0 g (0.25 mol Si—H,) polymethylhydrosiloxane, 3.95 g (0.025 mol, 10% of Si—H) 4-allyloxymethyl-[1,3]dioxolan-2-one and 55.08 g AMPEO₃ (0.27 mol) by syringe. To this stirred heterogeneous precursor solution was syringed 150 mL of dry CH₃CN solvent and 500 μL Dicyclopentidiene Platinum (II) dichloride solution in CH₂Cl₂ (7.5×10⁻³ M). The flask was then heated to 80° C. while stirring. After 30 min, the cloudy mixture became a clear solution. The reaction process was monitored and the reaction was found to be complete after 96 h, when no Si—H peak at 4.6 ppm or CH₂═CH— signals at 5-6 ppm were observed in ¹H-NMR spectrum.

### EXAMPLE 4

The generalized reaction illustrated in FIG. 1 was employed to generate a polysiloxane with: R as CH₃; R′ as hydrogen; R″ as CH₃; R′∝as CH₃; R₃ as CH₂O; R₄ as CH₂OCH₂; Z as methyl; n: m=2:8; n+m˜33; p=3; and q=1. To a 3-necked, 250 mL, flame dried flask equipped with a condenser was added 15.0 g (0.25 mol Si—H) polymethylhydrosiloxane, 7.9 g (0.05 mol, 20% of Si—H) 4-allyloxymethyl-[1,3]dioxolan-2-one and 48.96 g AMPEO₃ (0.24 mol) by syringe. To this stirred heterogeneous precursor solution was syringed 150 mL of dry CH₃CN solvent and 500 μL platinum catalyst solution in CH₂Cl₂. The flask was then heated to 80° C. while stirring. After 30 min, the cloudy mixture became a clear solution. The reaction process was monitored and the reaction was found to be complete after 96 h, when no Si—H peak at 4.6 ppm or CH₂═CH— signals at 5-6 ppm were observed in ¹H-NMR spectrum.

### EXAMPLE 5

The generalized reaction illustrated in FIG. 1 was employed to generate a polysiloxane with: R as CH₃; R′ as hydrogen; R″ as CH₃; R′∝as CH₃; R₃ as CH₂O; R₄ as CH₂OCH₂; Z as methyl; n:m=3:7; n+m˜33; p=3; and q=1. To a 3-necked, 250 mL, flame dried flask equipped with a condenser was added 15.0 g (0.25 mol Si—H) polymethylhydrosiloxane, 11.85 g (0.075 mol, 50% of Si—H) 4-allyloxymethyl-[1,3]dioxolan-2-one and 42.84 g AMPEO₃ (0.21 mol) by syringe. To this stirred heterogeneous precursor solution was syringed 150 mL of dry CH₃CN solvent and 500 μL platinum catalyst solution in CH₂Cl₂. The flask was then heated to 80° C. while stirring. After 30 min, the cloudy mixture became a clear solution. The reaction process was monitored and the reaction was found to be complete after 96 h, when no Si—H peak at 4.6 ppm or CH₂═CH— signals at 5-6 ppm were observed in ¹H-NMR spectrum.

### EXAMPLE 6

The generalized reaction illustrated in FIG. 1 was employed to generate a polysiloxane with: R as CH₃; R′ as hydrogen; R″ as CH₃; R′∝as CH₃; R₃ as CH₂O; R₄ as CH₂OCH₂; Z as methyl; n:m=1: 9; n+m˜6; p=3; and q=1. To a 3-necked, 250 mL, flame dried flask equipped with a condenser was added 19.26 g (0.24 mol Si—H) short chain polymethylhydrosiloxane, 3.8 g (0.024 mol, 10% of Si—H) 4-allyloxymethyl-[1,3]dioxolan-2-one and 52.8 g AMPEO₃ (0.26 mol, 20% excess) by syringe. To this stirred heterogeneous precursor solution was syringed 140 mL of dry CH₃CN solvent and 50 μL Karstedt's catalyst (divinyltetramethyldisiloxane [Pt(dvs)], 3% in xylene solution, from Aldrich). The flask was then heated to 80° C. while stirring. After 30 min, the cloudy mixture became a clear solution. The reaction process was monitored and the reaction was found to be complete after 96 h, when no Si—H peak at 4.6 ppm or CH₂═CH— signals at 5-6 ppm were observed in ¹H-NMR spectrum.

### EXAMPLE 7

The generalized reaction illustrated in FIG. 1 was employed to generate a polysiloxane with: R as CH₃; R′ as hydrogen; R″ as CH₃; R′″ as CH₃; R₃ as CH₂O; R₄ as; Z as methyl; n: m=2:8; n+m˜6; p=3; and q=1. To a 3-necked, 100 mL, flame dried flask equipped with a condenser was added 6.42 g (0.08 mol Si—H) short chain polymethylhydrosiloxane, 2.53 g (0.016 mol, 20% of Si—H) 4-allyloxymethyl-[1,3]dioxolan-2-one and 15.66 g AMPEO₃ (0.0768 mol, 20% excess) by syringe. To this stirred heterogeneous precursor solution was syringed 130 mL of dry CH₃CN solvent and 50 μL Karstedt's catalyst solution xylene (3%). The flask was then heated to 80° C. while stirring. After 30 min, the cloudy mixture became a clear solution. The reaction process was monitored and the reaction was found to be complete after 96 h, when no Si—H peak at 4.6 ppm or CH₂═CH— signals at 5-6 ppm were observed in ¹H-NMR spectrum.

### EXAMPLE 8

The generalized reaction illustrated in FIG. 1 was employed to generate a polysiloxane with: R as CH₃; R′ as hydrogen; R″ as CH₃; R′″ as CH₃; R₃ as CH₂O; R₄ as; Z as methyl; n:m=3:7; n+m˜6; p=3; and q=1. To a 3-necked, 250 mL, flame dried flask equipped with a condenser was added 19.26 g (0.24 mol Si—H) short chain polymethylhydrosiloxane, 11.4 g (0.072 mol, 30% of Si—H) 4-allyloxymethyl-[1,3]dioxolan-2-one and 41.1 g AMPEO₃ (0.20 mol, 20% excess) by syringe. To this stirred heterogeneous precursor solution was syringed 140 mL of dry CH₃CN solvent and 100 μL Karstedt's catalyst solution xylene (3%). The flask was then heated to 80° C. while stirring. After 30 min, the cloudy mixture became a clear solution. The reaction process was monitored and the reaction was found to be complete after 96 h, when no Si—H peak at 4.6 ppm or CH₂═CH— signals at 5-6 ppm were observed in ¹H-NMR spectrum.

### EXAMPLE 9

LiTFSI salt (LiN(CF₃SO₂)₂) was dissolved in the polysiloxanes generated in Examples 3-8 to form a liquid electrolyte having a [EO]/[Li]=15. The ionic conductivities of the electrolytes were determined from AC impedance curves of 2032 button cells assembled by injecting the electrolyte between two stainless steel discs with a Teflon O-ring (1/32 inch thick) to prevent short circuits. The measurement frequency range was from 1 MHz to 10 Hz. The results are presented in Table 1. Table 2 is provided for the purposes of comparison. Table 2 presents conductivity data for an electrolyte having LiTFSI dissolved in a polysiloxane represented by

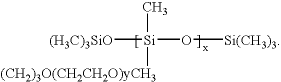

Accordingly, the polysiloxanes employed to generate the data in Table 1 include a cyclic carbonate moiety while the polysiloxanes employed to generate the data in Table 2 do not include a cyclic carbonate moiety. The cyclic carbonate moiety provides the polysiloxane with an enhanced ionic conductivity.

The electrolytes described above can be used in electrochemical devices. For instance, the electrolytes can be used as the electrolyte of batteries, capacitors, and hybrid capacitor/batteries. As an example, the electrolyte can be applied to batteries in the same way as carbonate-based electrolytes. Batteries with a liquid electrolyte can be fabricated by injecting the electrolyte into a spiral wound cell or prismatic type cell. The electrolyte can be also coated onto the surface of electrodes and assembled with a porous separator to fabricate a single or multi-stacked cell that can enable the use of flexible packaging.

TABLE 1

| Exam- | | | [EO]/ | Conductivity | Conductivity |
|---|---|---|---|---|---|
| ple # | N:m | (n + m) | [Li] | (Rm. Temp., S/cm) | (37° C., S/cm) |
| 3 | 1:9 | ˜33 | 15 | 1.62 × 10⁻⁴ | 2.46 × 10⁻⁴ |
| 4 | 2:8 | ˜33 | 15 | 9.81 × 10⁻⁵ | 1.63 × 10⁻⁴ |
| 5 | 3:7 | ˜33 | 15 | 9.04 × 10⁻⁵ | 1.49 × 10⁻⁴ |
| 6 | 1:9 | ˜6 | 15 | 1.56 × 10⁻⁴ | 2.57 × 10⁻⁴ |
| 7 | 2:8 | ˜6 | 15 | 1.33 × 10⁻⁴ | 2.15 × 10⁻⁴ |
| 8 | 3:7 | ˜6 | 15 | 1.14 × 10⁻⁴ | 1.89 × 10⁻⁴ |

TABLE 2

| | | | Conductivity | Conductivity |
|---|---|---|---|---|
| X | Y | [EO]/[Li] | (Rm. Temp., S/cm) | (37° C., S/cm) |
| 4 | 3 | 15 | 8.38 × 10⁻⁵ | 1.34 × 10⁻⁴ |
| 6 | 3 | 15 | 9.46 × 10⁻⁵ | 1.34 × 10⁻⁴ |
| 6 | 7.2 | 15 | 7.12 × 10⁻⁵ | 1.36 × 10⁻⁴ |
| 7 | 3 | 15 | 9.61 × 10⁻⁵ | 1.57 × 10⁻⁴ |
| 9 | 3 | 15 | 7.47 × 10⁻⁵ | 1.23 × 10⁻⁴ |
| 33 | 3 | 32 | 5.53 × 10⁻⁵ | 8.10 × 10⁻⁵ |

The electrolytes described above can be used in electrochemical devices. For instance, the electrolytes can be used as the electrolyte of batteries, capacitors, and hybrid capacitor/batteries. As an example, the electrolyte can be applied to batteries in the same way as carbonate-based electrolytes. Batteries with a liquid electrolyte can be fabricated by injecting the electrolyte into a spiral wound cell or prismatic type cell. The electrolyte can be also coated onto the surface of electrodes and assembled with a porous separator to fabricate a single or multi-stacked cell that can enable the use of flexible packaging.

The solid and/or gel electrolytes described above can also be applied to electrochemical devices in the same way as solid carbonate-based electrolytes. For instance, a precursor solution having components for a solid electrolyte can be applied to one or more substrates. Suitable substrates include, but are not limited to, anodes, cathodes and/or separators such as a polyolefin separator, nonwoven separator or polycarbonate separator. The precursor solution is converted to a solid or gel electrolyte such that a film of the electrolyte is present on the one or more substrates. In some instances, the substrate is heated to solidify the electrolyte on the substrate. An electrochemical cell can be formed by positioning a separator between an anode and a cathode such that the electrolyte contacts the anode and the cathode.

An example of a suitable lithium battery construction includes one or more lithium metal oxide cathodes, one or more porous separators, and one or more anodes made of carbon, lithium metal, or combinations thereof. Cathodes may include LiₓVO_{y}, LiCoO₂, LiNiO₂, LiNi₁₋ₓCo_{y}Me_{z}O₂, LiMn_{0.5}Ni_{0.5}O₂, LiMn_{0.3}Co_{0.3}Ni_{0.3}O₂, LiFePO₄, LiMn₂O₄, LiFeO₂, LiMc_{0.5}Mn1.5O₄, vanadium oxide, carbon fluoride and mixtures thereof. Me is Al, Mg, Ti, B, Ga, Si, Mn, or Zn, and combinations thereof. Mc is a divalent metal such as Ni, Co, Fe, Cr, Cu and combinations thereof. Anodes may include graphite, soft carbon, hard carbon, Li₄Ti₅O₁₂, tin alloys, silica alloys, intermetallic compounds, lithium metal, lithium metal alloys, and combinations thereof.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. An electrochemical device, comprising:
a liquid electrolyte including a polysiloxane having one or more backbone silicons linked to a first side chain and one or more backbone silicons linked to a second side chain, the first side chains including a poly(alkylene oxide) moiety and the second side chains including a cyclic carbonate moiety.

2. The device of claim 1, wherein each of the non-terminal silicons in the backbone of the polysiloxane are linked to at least one side chain selected from a group consisting of a first side chain and a second side chain.

3. The device of claim 1, wherein the polysiloxane excludes Si—H groups.

4. The device of claim 1, wherein the first side chains include a first spacer positioned between the poly(alkylene oxide) moiety and the backbone of the polysiloxane and the second side chains include a second spacer positioned between the cyclic carbonate moiety and the backbone of the polysiloxane, the first spacer including one or more CH₂ groups and the second spacer including one or more CH₂ groups.

5. The device of claim 1, wherein the polysiloxane has a structure according to General 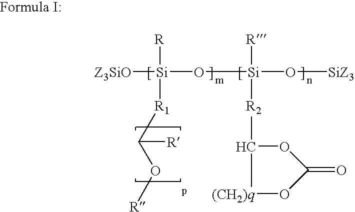
where R is an alkyl group; R′ is hydrogen or an alkyl group; R″ is an alkyl group; R′″ is alkyl; R₁ is an alkylene, alkylene oxide or bivalent ether moiety; R₂ is an alkylene, alkylene oxide or bivalent ether moiety; m is greater than or equal to 1 and n is greater than or equal to 1; p is 3 to 20; q is 1 to 2; and Z is an alkyl or aryl group.

6. The device of claim 1, wherein the average molecular weight for the polysiloxane is less than or equal to 4000 g/mole.

7. The device of claim 1, wherein the electrolyte includes lithium ions and wherein a [EO]/[Li] ratio is 5 to 50, [EO] being the molar concentration of the active oxygens in the electrolyte and [Li] being the molar concentration of the lithium ions in the electrolyte.

8. An electrochemical device, comprising:
an electrolyte including a polysiloxane, each of the non-terminal silicons in the backbone of the polysiloxane being linked to at least one entity selected from a group consisting of: first side chains that include a poly(alkylene oxide) moiety and second side chains that include a cyclic carbonate moiety.

9. The device of claim 8, wherein the polysiloxane excludes Si—H groups.

10. The device of claim 8, wherein the first side chains include a first spacer positioned between the poly(alkylene oxide) moiety and the backbone of the polysiloxane and the second side chains include a second spacer positioned between the cyclic carbonate moiety and the backbone of the polysiloxane, the first spacer including one or more CH₂ groups and the second spacer including one or more CH₂ groups.

11. The device of claim 8, wherein the polysiloxane has a structure according to General 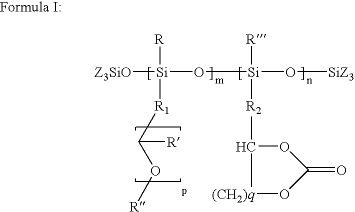
where R is an alkyl group; R′ is hydrogen or an alkyl group; R″ is an alkyl group; R′″ is alkyl; R₁ is an alkylene, alkylene oxide or bivalent ether moiety; R₂ is an alkylene, alkylene oxide or bivalent ether moiety; m is greater than or equal to 1; n is greater than or equal to 1; p is 3 to 20; q is 1 to 2; and Z is an alkyl or aryl group.

12. The device of claim 8, wherein the average molecular weight for the polysiloxane is less than or equal to 4000 g/mole.

13. The device of claim 8, wherein the electrolyte includes lithium ions and wherein a [EO]/[Li] ratio is 5 to 50, [EO] being the molar concentration of the active oxygens in the electrolyte and [Li] being the molar concentration of the lithium ions in the electrolyte.

14. A precursor solution for use in generating a polysiloxane, comprising:
a polysiloxane precursor wherein each of the non-terminal backbone silicons is member of at least one Si—H group, a first side-chain precursor including a poly(alkylene oxide) moiety and being allyl terminated, and a second side-chain precursor including a cyclic carbonate moiety and being allyl terminated; and
the polysiloxane precursor, the first side-chain precursor and the second side-chain precursor present in the solution so as to provide the solution with a ratio, [SC]/[Si—H], greater than 1:1, [SC]/[Si—H] being the ratio of (the molar concentration of the first side-chain precursor in the solution+the molar concentration of the second side-chain precursor in the solution):(the molar concentration of the Si—H groups on backbone of the polysiloxane precursor in the solution).

15. The solution of claim 14, wherein [SC]/[Si—H] is greater than 1.1:1.

16. The solution of claim 14, wherein [SC]/[Si—H] is less than 3:1.

17. The solution of claim 14, wherein the first side-chain precursor and the second side-chain precursor are present in the solution at concentrations that provide a side-chain precursor ratio greater than 1:1, the side-chain precursor ratio being the ratio of the molar concentration of the second side-chain precursor to the molar concentration of the first side-chain precursor.

18. The solution of claim 17, the side-chain precursor ratio is less than 1:20.

19. The solution of claim 14, further comprising:
a platinum catalyst.

20. A method of forming an electrolyte that is suitable for use in an electrochemical device, comprising:
generating a precursor solution that includes a polysiloxane precursor where each of the non-terminal backbone silicons is member of at least one Si—H group, a first side-chain precursor including a poly(alkylene oxide) moiety and being allyl terminated, and a second side-chain precursor including a cyclic carbonate moiety and being allyl terminated; the components being mixed so as to provide a ratio, [SC]/[Si—H], greater than 1:1, [SC]/[Si—H] being the ratio of (the molar concentration of the first side-chain precursor in the solution+the molar concentration of the second side-chain precursor in the solution): (the molar concentration of the Si—H groups on backbone of the polysiloxane precursor in the solution).

21. The method of claim 20, wherein the components are mixed so as to provide [SC]/[Si—H] greater than 1.1:1.

22. The method of claim 20, wherein the components are mixed so as to provide [SC]/[Si—H] greater than 3:1.

23. The method of claim 20, wherein the components are mixed so as to provide a side-chain precursor ratio greater than 1:1, the side-chain precursor ratio being the ratio of the molar concentration of the second side-chain precursor to the molar concentration of the first side-chain precursor.

24. The method of claim 23, wherein the components are mixed so as to provide a side-chain precursor ratio less than 1:20.

25. The method of claim 20, further comprising:
reacting the components of the precursor solution so as to form a product solution that includes a polysiloxane having one or more backbone silicons linked to a first side chain and one or more backbone silicons linked to a second side chain, the first side chains including a poly(alkylene oxide) moiety and the second side chains including a cyclic carbonate moiety.

26. The method of claim 25, further comprising:
removing one or more components from the product solution, the one or more components including at least one component selected from the group consisting of: first side-chain precursor remaining in the product solution and second side-chain precursor remaining in the product solution.

27. The method of claim 26, further comprising:
dissolving a salt in the product solution after removing the one or more components.

28. An electrochemical device, comprising:
an electrolyte including
a polysiloxane having one or more backbone silicons linked to a first side chain and one or more backbone silicons linked to a second side chain, the first side chains including a poly(alkylene oxide) moiety and the second side chains including a cyclic carbonate moiety, and
a cross-linked network polymer having interstices in which the polysiloxane is positioned.

29. The device of claim 28, wherein the first side chains include a first spacer positioned between the poly(alkylene oxide) moiety and the backbone of the polysiloxane and the second side chains include a second spacer positioned between the cyclic carbonate moiety and the backbone of the polysiloxane, the first spacer including one or more CH₂ groups and the second spacer including one or more CH₂ groups.

30. The device of claim 29, wherein the polysiloxane has a structure according to General 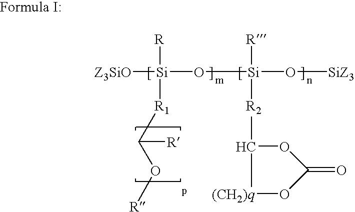
where R is an alkyl group; R′ is hydrogen or an alkyl group; R″ is an alkyl group; R′″ is alkyl; R₁ is an alkylene, alkylene oxide or bivalent ether moiety; R₂ is an alkylene, alkylene oxide or bivalent ether moiety; m is greater than or equal to 1; n is greater than or equal to 1; p is 3 to 20; q is 1 to 2; and Z is an alkyl or aryl group.

31. The device of claim 28, wherein the average molecular weight for the polysiloxane is less than or equal to 4000 g/mole.

32. The device of claim 28, wherein the electrolyte includes lithium ions and wherein a [EO]/[Li] ratio is 5 to 50, [EO] being the molar concentration of the active oxygens in the electrolyte and [Li] being the molar concentration of the lithium ions in the electrolyte.

33. The device of claim 28, wherein the electrolyte is a solid.

34. The device of claim 28, wherein the electrolyte is a gel.

35. The device of claim 28, wherein the network polymer interacts with the polysiloxane so as to form an interpenetrating network.

36. The device of claim 28, wherein the network polymer includes a polyacrylate or a polymethacrylate.

37. The device of claim 28, wherein the network polymer is a polymer of a dialkyl acrylate, a dimethacrylate, a diallyl terminated compound or a dialkyl methacrylate.

38. A method of generating an electrochemical device, comprising:
generating an electrolyte that includes
a polysiloxane having one or more backbone silicons linked to a first side chain and one or more backbone silicons linked to a second side chain, the first side chains including a poly(alkylene oxide) moiety and the second side chains including a cyclic carbonate moiety, and
a cross-linked network polymer having interstices in which the polysiloxane is positioned; and
activating one or more electrodes and one or more anodes with the electrolyte.

39. The method of claim 38, wherein the first side chains include a first spacer positioned between the poly(alkylene oxide) moiety and the backbone of the polysiloxane and the second side chains include a second spacer positioned between the cyclic carbonate moiety and the backbone of the polysiloxane, the first spacer including one or more CH₂ groups and the second spacer including one or more CH₂ groups.

40. The method of claim 38, wherein the polysiloxane has a structure according to General 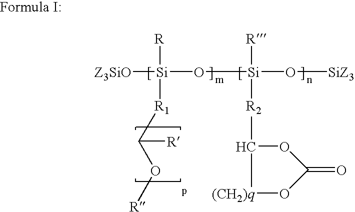
where R is an alkyl group; R′ is hydrogen or an alkyl group; R″ is an alkyl group; R′″ is alkyl; R₁ is an alkylene, alkylene oxide or bivalent ether moiety; R₂ is an alkylene, alkylene oxide or bivalent ether moiety; m is greater than or equal to l; n is greater than or equal to 1; p is 3 to 20; q is 1 to 2; and Z is an alkyl or aryl group.

41. The method of claim 38, wherein the average molecular weight for the polysiloxane is less than or equal to 4000 g/mole.

42. The method of claim 38, wherein the electrolyte includes lithium ions and wherein a [EO]/[Li] ratio is 5 to 50, [EO] being the molar concentration of the active oxygens in the electrolyte and [Li] being the molar concentration of the lithium ions in the electrolyte.

43. The method of claim 38, wherein generating the electrolyte includes forming a precursor solution that includes the polysiloxane and monomers for forming the cross-linked network polymer.

44. The method of claim 43, wherein the precursor solution includes a radical initiator.

45. The method of claim 43, wherein one or more of the monomers are selected from a group consisting of: a dialkyl acrylate, a dimethacrylate, a diallyl terminated compound or a dialkyl methacrylate.

46. The method of claim 43, wherein one or more of the monomers has a structure according to Formula IV: 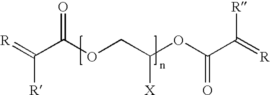
wherein R is an alkyl group having 1 to 10 carbon atoms; R′ is a hydrogen or an alkyl group having 1 to 10 carbon atoms or an alkenyl group having 2 to 12 carbon atoms; R″ is a hydrogen or an alkyl group having 1 to 10 carbon atoms or an alkenyl group having 2 to 12 carbon atoms; X is hydrogen or a methyl group; and n represents a numeral of 1 to 15.

47. The method of claim 43, wherein the precursor solution includes a control monomer for controlling cross-linking density.

48. The method of claim 47, wherein the control monomer has a structure according to 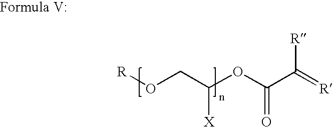
where R is an alkyl group having 1 to 10 carbon atoms, R′ is an alkyl group having 1 to 10 carbon atoms; R″ is hydrogen or a group selected from an alkyl group having 1 to 10 carbon atoms and/or an alkenyl group having 2 to 12 carbon atoms; X is hydrogen or a methyl group; and n represents a whole number from 1 to 20.

49. An electrochemical device, comprising:
a liquid electrolyte including
a polysiloxane having one or more backbone silicons linked to a first side chain and one or more backbone silicons linked to a second side chain, the first side chains including a poly(alkylene oxide) moiety and the second side chains including a cyclic carbonate moiety, and
a solid polymer, the solid polymer being a solid at room temperature when standing alone.

50. The device of claim 49, wherein the first side chains include a first spacer positioned between the poly(alkylene oxide) moiety and the backbone of the polysiloxane and the second side chains include a second spacer positioned between the cyclic carbonate moiety and the backbone of the polysiloxane, the first spacer including one or more CH₂ groups and the second spacer including one or more CH₂ groups.

51. The device of claim 49, wherein the polysiloxane has a structure according to General 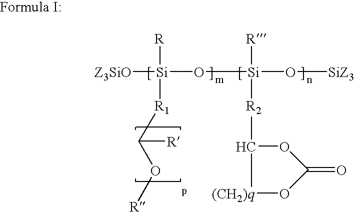
where R is an alkyl group; R′ is hydrogen or an alkyl group; R″ is an alkyl group; R′″ is alkyl; R₁ is an alkylene, alkylene oxide or bivalent ether moiety; R₂ is an alkylene, alkylene oxide or bivalent ether moiety; m is greater than or equal to 1; n is greater than or equal to 1; p is 3 to 20; q is 1 to 2; and Z is an alkyl or aryl group.

52. The device of claim 49, wherein the average molecular weight for the polysiloxane is less than or equal to 4000 g/mole.

53. The device of claim 49, wherein the electrolyte includes lithium ions and wherein a [EO]/[Li] ratio is 5 to 50, [EO] being the molar concentration of the active oxygens in the electrolyte and [Li] being the molar concentration of the lithium ions in the electrolyte.

54. The device of claim 49, wherein the solid polymer includes one or more components selected from the group consisting of: polyacrylonitrile (PAN), poly(methyl methacrylate) (PMMA), poly(vinylidene fluoride) (PVDF), poly(vinylidene fluoride-co-hexafluoropropylene), polystyrene, polyvinyl chloride, poly(alkyl methacrylate), poly(alkyl acrylate), styrene butadiene rubber (SBR), poly(vinyl acetate) and poly(ethylene oxide) (PEO).

55. A method of forming an electrochemical device, comprising:
generating an electrolyte that includes
a polysiloxane having one or more backbone silicons linked to a first side chain and one or more backbone silicons linked to a second side chain, the first side chains including a poly(alkylene oxide) moiety and the second side chains including a cyclic carbonate moiety, and
a cross-linked network polymer having interstices in which the polysiloxane is positioned; and
a solid polymer, the solid polymer being a solid at room temperature when standing alone.

56. The method of claim 55, wherein the first side chains include a first spacer positioned between the poly(alkylene oxide) moiety and the backbone of the polysiloxane and the second side chains include a second spacer positioned between the cyclic carbonate moiety and the backbone of the polysiloxane, the first spacer including one or more CH₂ groups and the second spacer including one or more CH₂ groups.

57. The method of claim 55, wherein the polysiloxane has a structure according to General 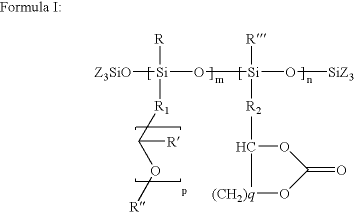
where R is an alkyl group; R′ is hydrogen or an alkyl group; R″ is an alkyl group; R′″ is alkyl; R₁ is an alkylene, alkylene oxide or bivalent ether moiety; R₂ is an alkylene, alkylene oxide or bivalent ether moiety; m is greater than or equal to 1; n is greater than or equal to 1; p is 3 to 20; q is 1 to 2; and Z is an alkyl or aryl group.

58. The method of claim 55, wherein the average molecular weight for the polysiloxane is less than or equal to 4000 g/mole.

59. The method of claim 55, wherein the electrolyte includes lithium ions and wherein a [EO]/[Li] ratio is 5 to 50, [EO] being the molar concentration of the active oxygens in the electrolyte and [Li] being the molar concentration of the lithium ions in the electrolyte.

60. The method of claim 55, wherein the solid polymer includes one or more components selected from the group consisting of: polyacrylonitrile (PAN), poly(methyl methacrylate) (PMMA), poly(vinylidene fluoride) (PVDF), poly(vinylidene fluoride-co-hexafluoropropylene), polystyrene, polyvinyl chloride, poly(alkyl methacrylate), poly(alkyl acrylate), styrene butadiene rubber (SBR), poly(vinyl acetate) and poly(ethylene oxide) (PEO).

61. The method of claim 55, wherein generating the electrolyte includes generating a precursor solution that includes the polysiloxane and the solid polymer.

62. The method of claim 61, wherein generating the precursor solution includes mixing the polysiloxane and a solution that includes the solid polymer dissolved in a solvent.

63. The method of claim 62, wherein generating the precursor solution includes evaporating the solvent from the precursor solution.

64. The method of claim 61, wherein generating the precursor solution includes mixing the polysiloxane and monomers for the solid polymer.

65. The method of claim 64, wherein generating the precursor solution includes polymerizing the monomer.
